(19) United States
(12) Patent Application Publication
(10) Pub. No.: US 2025/0390260 A1
(43) Pub. Date: Dec. 25, 2025

(54) PRINTING APPARATUS, CONTROL METHOD FOR PRINTING APPARATUS, AND STORAGE MEDIUM

(71) Applicant: CANON KABUSHIKI KAISHA, Tokyo (JP)

(72) Inventor: JUN TANAKA, Ibaraki (JP)

(21) Appl. No.: 19/236,715

(22) Filed: Jun. 12, 2025

(30) Foreign Application Priority Data
Jun. 20, 2024 (JP) 2024-099544

(51) Int. Cl. G06F 3/12

(52) U.S. Cl. CPC G06F 3/1239; G06F 3/1207; G06F 3/1238; G06F 3/1241

(57) ABSTRACT

A printing apparatus includes a printing unit, at least one processor, and a memory in communication with the processor storing instructions that, when executed by the processor, cause the processor to display a screen for accepting a first quantity by which a printing count value is counted up when an image is printed in monochrome on one sheet and a second quantity by which the printing count value is counted up when an image is printed in color on one sheet and restrict printing performed by the printing unit based on the printing count value and a printing upper limit value.

### BACKGROUND

### Field

The present disclosure relates to a printing apparatus, a control method for the printing apparatus, and a storage medium.

### Description of the Related Art

Conventionally, a flat-rate printing system (a fixed-price printing system) has been used as a rental service system provided to users who wish to use an image forming apparatus without connecting the image forming apparatus to the Internet. With the flat-rate printing system, a user pays a fixed amount for each predetermined period based on a maintenance contract, which enables the user to print a preset permitted number of pages to be printed, and also provides maintenance and repairs for the image forming apparatus that is being rented and in use.

In addition, there is also a known method of setting the permitted number of pages to be printed according to the amount paid by the user (for example, see Japanese Laid-Open Patent Publication (kokai) No. 2005-352902).

In recent years, rental services provided through flat-rate printing systems have become more diverse, with the ability to set the permitted number of pages to be printed and the period during which each function can be used.

This enables rental services that enable rental service providers to set a usable range that differs from a conventional maintenance contract, in which the image forming apparatus that is being rented and in use is cannot be used once the permitted number of pages to be printed is reached, are becoming more widespread.

The technique disclosed in Japanese Laid-Open Patent Publication (kokai) No. 2005-352902 and recent rental services do not enable a charge rate to be changed based on differences in printing methods such as a paper size and a color setting (i.e., color printing or monochrome printing) that are used for printing.

This has inhibited providing a rental service that meets the needs of customers and the market by, for example, setting a lower color printing charge rate for customers who frequently perform the color printing, and conversely, setting a lower monochrome printing charge rate for customers who frequently perform the monochrome printing.

### SUMMARY

The present disclosure provides a printing apparatus comprising a printing unit, at least one processor, and a memory in communication with the processor storing instructions that, when executed by the processor, cause the processor to display a screen for accepting a first quantity by which a printing count value is counted up when an image is printed in monochrome on one sheet, and a second quantity by which the printing count value is counted up when an image is printed in color on one sheet and restrict printing performed by the printing unit based on the printing count value and a printing upper limit value.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of an image forming apparatus according to a first embodiment.

FIG. 2 is a block diagram illustrating a software configuration of the image forming apparatus (a multi-function peripheral (MFP)) illustrated in FIG. 1.

FIG. 3 is a flowchart illustrating a procedure of a conventional print restriction processing.

FIG. 4A and FIG. 4B are diagrams illustrating an example of a screen for setting an upper limit number of pages to be printed, which is used in the conventional print restriction processing.

FIG. 5A and FIG. 5B are diagrams illustrating screen displays in the conventional print restriction processing.

FIGS. 6A, 6B, 6C, 6D, 6E, and 6F are diagrams illustrating screens according to the first embodiment, which are displayed on an operation unit illustrated in FIG. 1.

FIG. 7A is a flowchart illustrating a procedure of a print prohibition processing executed by the MFP illustrated in FIG. 1.

FIG. 7B is a flowchart illustrating a procedure of a count-up processing when executing printing according to the first embodiment, which is executed by the MFP illustrated in FIG. 1.

FIG. 8A and FIG. 8B are diagrams illustrating an example of a screen displayed on the operation unit in the print prohibition processing illustrated in FIG. 7A.

FIGS. 9A, 9B, 9C, and 9D are diagrams illustrating examples of screens displayed on the operation unit when a print prohibition state is set in step S7110 of FIG. 7A.

FIG. 10 is a diagram illustrating a screen according to a second embodiment, which is displayed on the operation unit illustrated in FIG. 1.

FIG. 11 is a flowchart illustrating a procedure of a count-up processing when executing printing according to the second embodiment, which is executed by the MFP illustrated in FIG. 1.

### DESCRIPTION OF THE EMBODIMENTS

The present disclosure will be described in detail below with reference to the accompanying drawings illustrating embodiments thereof.

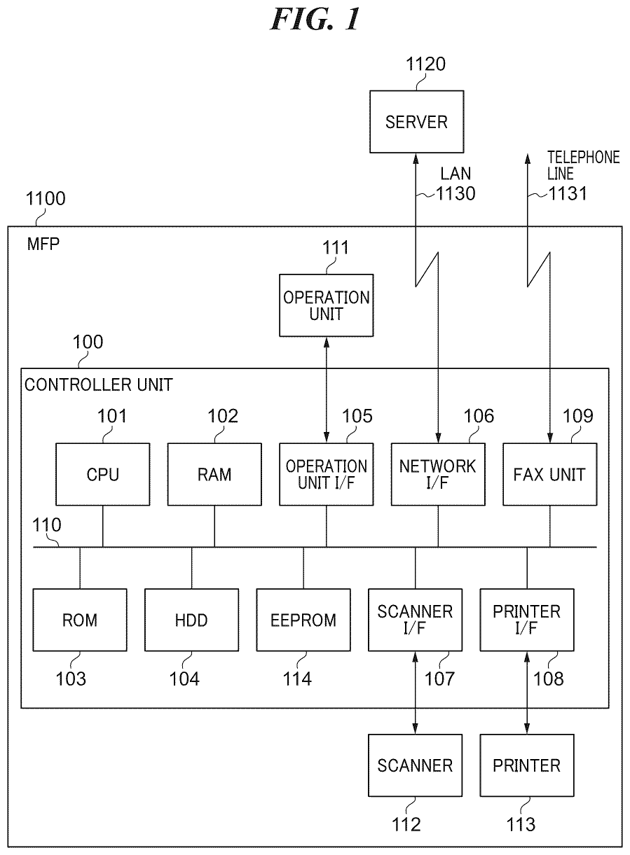

A first embodiment will now be described. FIG. 1 is a block diagram illustrating a hardware configuration of an image forming apparatus according to the first embodiment. In the first embodiment, an MFP 1100, which includes a copy function, a scan function, a print function, and a FAX function, will be described as an example of an image forming apparatus (a printing apparatus).

The MFP 1100 is presumed to be an MFP provided by a rental service provider. A user can use the MFP 1100 based on the contents of a contract. In other words, the operation of the MFP 1100 serving as the image forming apparatus in the first embodiment is restricted based on the contents of the contract made by the user.

In the following description, a special mode used by a service person who installs the MFP 1100 is referred to as a service mode, and a screen displayed for operating the service mode is referred to as a service mode screen.

As illustrated in FIG. 1, the MFP 1100 is connected to a server 1120 via a network such as a local area network (a LAN) 1130. The MFP 1100 also includes a controller unit 100, an operation unit 111, a scanner 112, and a printer 113. The controller unit 100 is connected to the operation unit 111, the scanner 112, and the printer 113, respectively. The controller unit 100 includes a central processing unit (CPU) 101, a random-access memory (RAM) 102, a read only memory (ROM) 103, a hard disk drive (HDD) 104, an operation unit interface (operation unit I/F) 105, a network I/F 106, a scanner I/F 107, a printer I/F 108, a FAX unit 109, and an electrically erasable programmable read only memory (EEPROM) 114. The CPU 101, the RAM 102, the ROM 103, the HDD 104, the operation unit I/F 105, the network I/F 106, the scanner I/F 107, the printer I/F 108, the FAX unit 109, and the EEPROM 114 are connected to each other via a system bus 110.

The CPU 101 executes various types of control programs. Specifically, the CPU 101 starts up the MFP 1100 based on a boot program stored in the ROM 103. The CPU 101 reads out a control program stored in the HDD 104 and executes a predetermined processing using the RAM 102 as a working area.

The HDD 104 stores control programs for implementing various types of functions such as the copy function and the print function. The HDD 104 stores image data generated by the scanner 112 reading an image of a document.

The operation unit I/F 105 is an interface for connecting the operation unit 111 to the controller unit 100, and controls data input/output communication with the operation unit 111.

The network I/F 106 is connected to the LAN 1130, and controls input and output of information via the LAN 1130.

The scanner I/F 107 is an interface for connecting the scanner 112 to the controller unit 100, and obtains the image data from the scanner 112 and performs input and output of scanner control data.

The printer I/F 108 is an interface for connecting the printer 113 to the controller unit 100, and outputs output image data to the printer 113 and performs input and output of printer control data.

The FAX unit 109 performs transmission and reception of fax data via a telephone line 1131.

The operation unit 111 is a user interface that accepts instructions inputted by a user and presents information to a user, and includes input device(s) such as a touch panel and/or hard keys, and display device(s) such as a liquid crystal display (an LCD) and/or light emitting diodes (LEDs). The hard keys include a start button or the like for instructing the start of scanning a paper document.

The scanner 112 includes an optical reading device such as a charge coupled device (a CCD), and has a function of optically scanning a paper medium and reading it as electronic image data. The MFP 1100 has a function of automatically feeding a stack of paper documents placed on a document tray one-by-one to an optical reading section using an automatic document feeder (an ADF), and discharging the paper documents after the paper documents have been read. Whether a document has been placed on the document tray of the ADF is determined by a sensor (not illustrated) or the like. The printer 113 (a printing unit) has a function of performing a print processing that forms an image on a recording medium such as paper based on electronic image data. In the first embodiment, while a case where the recording medium to be printed by the printer 113 (the recording medium that is the target of the print processing performed by the printer 113) is paper will be described, the recording medium to be printed by the printer 113 may be a recording medium other than paper (a non-paper recording medium), such as film or plastic paper.

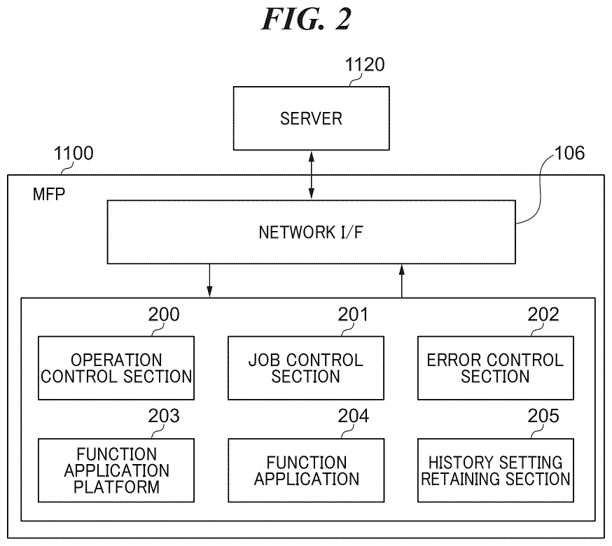

FIG. 2 is a block diagram illustrating a software configuration of the MFP 1100 illustrated in FIG. 1. As illustrated in FIG. 2, the MFP 1100 includes, as software modules, an operation control section 200, a job control section 201, an error control section 202, a function application platform 203, a function application 204, and a history setting retaining section 205. The processing performed by these software modules is realized by the CPU 101 executing a control program stored in the RAM 102, the ROM 103, or the HDD 104, and/or by communication with the server 1120 via the network I/F 106.

In the present disclosure, these software programs included in the MFP 1100 are stored in the RAM 102, the ROM 103, or the HDD 104, and are executed by the CPU 101. The MFP 1100 also executes software programs that realize various kinds of functions such as scanning, printing, and using the network or a memory storage.

The operation control section 200 has a function of controlling the operation unit I/F 105 to cause the operation unit 111 to display a screen operated by a user and to transmit the contents of a user's operation to another software program (software). The operation control section 200 controls the operation and display with respect to the hardware of the operation unit 111.

The job control section 201 controls the execution of a job. For example, when the job control section 201 receives an instruction to execute a scan job (a scan job execution instruction) from the function application 204, the job control section 201 controls the scanner 112 via the scanner I/F 107 to execute a scan processing. When the job control section 201 receives an instruction to execute a print job (a print job execution instruction) from the function application 204, the job control section 201 controls the printer 113 via the printer I/F 108 to execute a print processing.

The error control section 202 receives a notification of an abnormal state that occurs in the job control section 201, the printer 113, the scanner 112, or the like, and performs control to instruct the entire system to stop or instruct a degeneration operation.

The function application platform 203 converts information, which indicates the operation content of the operation unit 111 by a user received from the operation unit I/F 105, into an instruction or the like for each button on an operation screen controlled by the function application 204, and notifies the function application 204 of the converted information (the instruction or the like for each button on the operation screen). In addition, the function application platform 203 causes the operation unit 111 to switch the display of the operation screen via the operation unit I/F 105 based on an instruction to switch the operation screen (an operation screen switching instruction) received from the function application 204.

The function application 204 is a software module for implementing functions such as copying, printing, and email transmission. While only one function application 204 is illustrated in FIG. 2, the MFP 1100 includes a plurality of function applications 204 corresponding to the respective functions. In the MFP 1100, it is possible to add a new function application 204 based on data obtained from an external source. The addition of the new function application 204 is realized by being triggered, for example, by a user's instruction via the operation unit 111 or by receiving data via the network such as the LAN 1130.

The history setting retaining section 205 manages non-volatile information such as an operation history and various kinds of setting values within the MFP 1100. For example, the history setting retaining section 205 retains settings necessary for control during job execution, and saves a user operation history, job execution results, information about errors that have occurred, and the like. These pieces of information are retained in the HDD 104.

Next, in order to clarify the difference from a print prohibition processing in the first embodiment, a conventional print restriction processing that does not use a print permission condition mode, which will be described below, will be described.

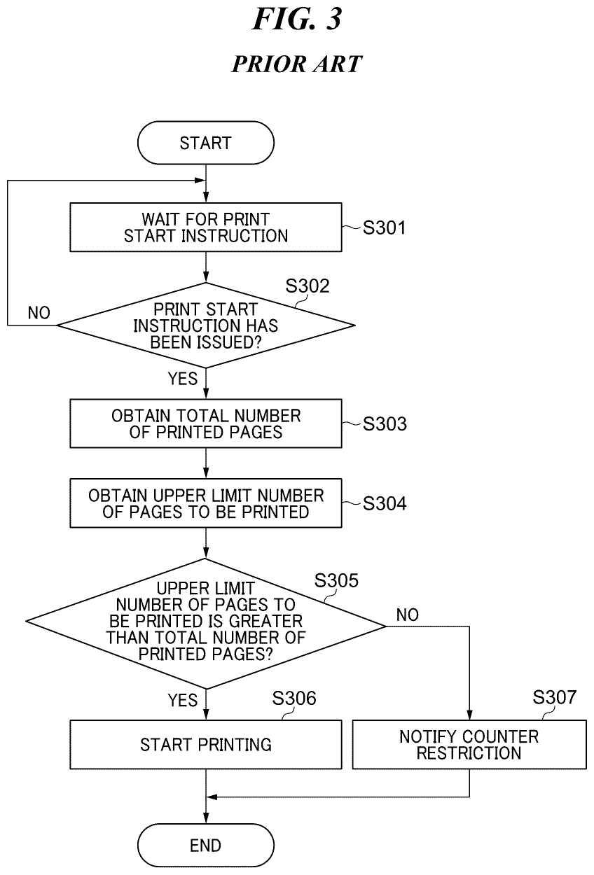

FIG. 3 is a flowchart that shows a procedure of the conventional print restriction processing. Execution of the conventional print restriction processing will be described with respect to MFP 1100. The conventional print restriction processing is realized by the CPU 101 executing a control program stored in the RAM 102, the ROM 103, or the HDD 104. In the conventional print restriction processing, the service person, who acts as an administrator of the MFP 1100, sets an upper limit number of pages to be printed when the MFP 1100 is installed.

As illustrated in FIG. 3, the job control section 201 waits until a print start instruction is issued from the function application 204 (step S301).

Then, in the case where a print start instruction has been issued (YES in step S302), the job control section 201 advances the conventional print restriction processing to step S303. In the case where a print start instruction has not been issued (NO in step S302), the job control section 201 returns the conventional print restriction processing to step S301.

In step S303, the job control section 201 obtains, from the history setting retaining section 205, a total number of pages that have been printed by the MFP 1100 (a total number of printed pages).

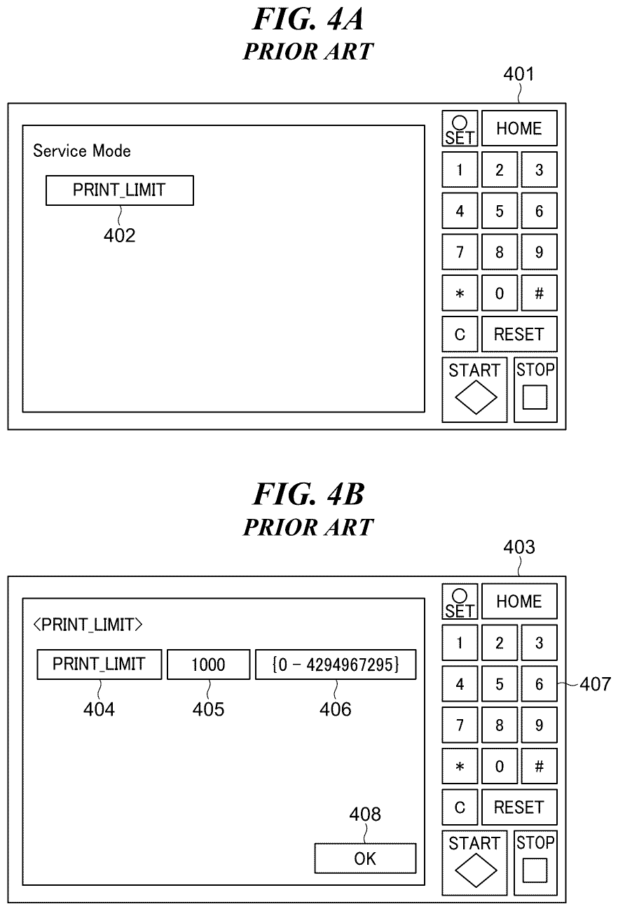

Next, the job control section 201 obtains, from the history setting retaining section 205, the upper limit number of pages to be printed that is currently set (s step S304). The upper limit number of pages to be printed is a value set in advance on the service mode screen that will be described below with reference to FIG. 4A and FIG. 4B.

The job control section 201 then determines whether the upper limit number of pages to be printed is greater than the total number of printed pages (step S305). In the case where the upper limit number of pages to be printed is greater than the total number of printed pages (YES in step S305), the job control section 201 controls the printer 113 via the printer I/F 108 to execute printing (step S306), and then ends the conventional print restriction processing.

In the case where the upper limit number of pages to be printed is less than or equal to the total number of printed pages (NO in step S305), the job control section 201 notifies the error control section 202 of an error (a counter restriction), which indicates that printing is not possible because the upper limit number of pages to be printed has been reached (step S307). The conventional print restriction processing then ends. When the error control section 202 is notified of the counter restriction by the job control section 201, the error control section 202 displays a message indicating the counter restriction on the operation unit 111 via the operation unit I/F 105. As a result, in the conventional print restriction processing, in the case where the total number of printed pages has reached a preset upper limit number of pages to be printed, additional printing can be stopped.

FIG. 4A and FIG. 4B illustrate an example of a screen for setting the upper limit number of pages to be printed, which is used in the conventional print restriction processing.

When the operation unit I/F 105 receives an operation to transition to the service mode screen from the operation unit 111, the operation unit I/F 105 causes the operation unit 111 to display a service mode screen 401 illustrated in FIG. 4A. The service mode screen 401 includes an operation menu and setting items that are used by the service person. A PRINT_LIMIT button 402 is an item for setting the upper limit number of pages to be printed. When the PRINT_LIMIT button 402 is selected, the operation unit I/F 105 causes the operation unit 111 to display a setting screen 403 illustrated in FIG. 4B. A setting item display section 404 of the setting screen 403 displays the name of an item to be set (an item name). In FIG. 4B, the setting item display section 404 displays “PRINT_LIMIT” which is the item name of the upper limit number of pages to be printed. An inputtable range display section 406 displays a range of values that can be inputted as the upper limit number of pages to be printed. An input section 405 displays the upper limit number of pages to be printed currently set. The upper limit number of pages to be printed can be changed by selecting a numeric keypad (407) and inputting a value. When the service person selects an OK button 408, the upper limit number of pages to be printed that has been changed is determined, and the upper limit number of pages to be printed that has been determined is saved in the history setting retaining section 205.

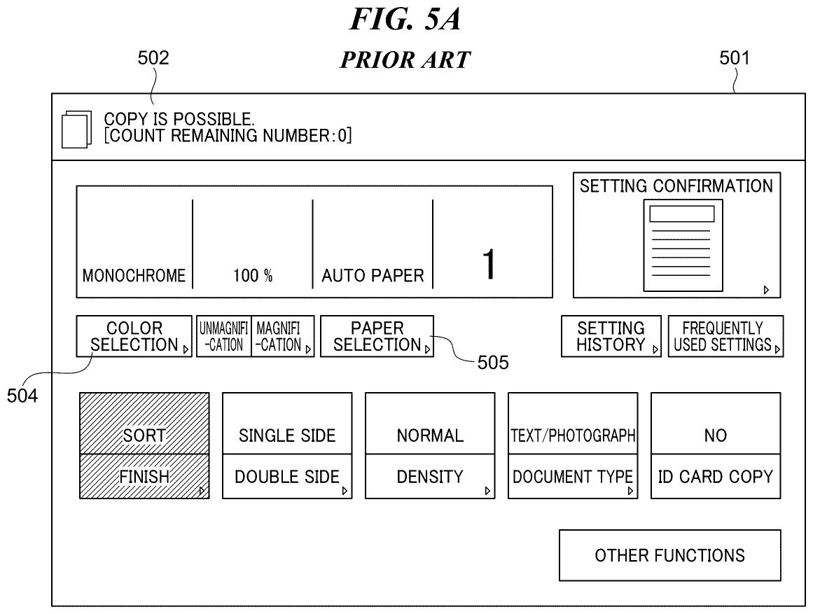

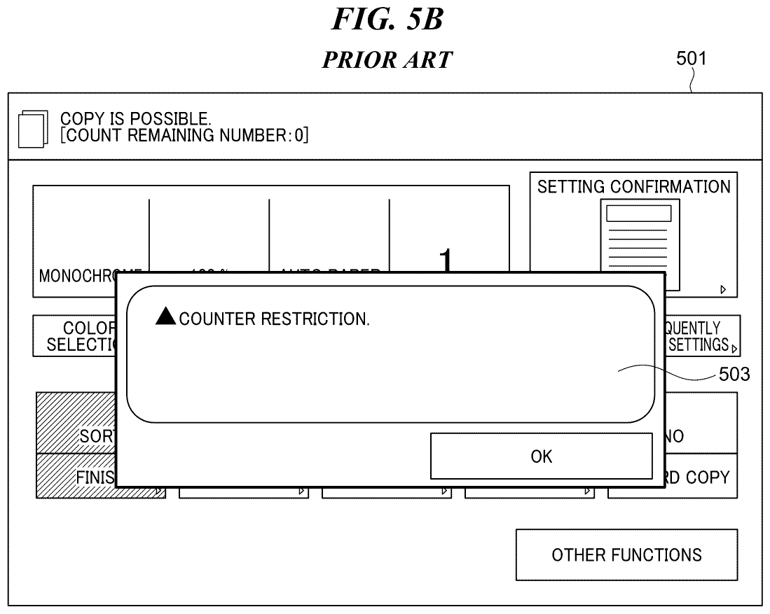

FIG. 5A and FIG. 5B illustrate screen displays in the conventional print restriction processing. A screen of the function application 204 having a copy function will be described as an example, but the same display may be performed for the function application 204 having other functions.

FIG. 5A illustrates an example of a copy setting screen before a print operation is received from the operation unit 111. A number-of-printable-pages display section 502 on a copy setting screen 501 displays a value, which is obtained by subtracting the current total number of printed pages from the upper limit number of pages to be printed, as a count remaining number. This display enables confirming the remaining number of printable pages. In addition, a user performs a print setting on the copy setting screen 501. For example, a color selection section 504 is a button enabling a user to input a color setting and to select performance of monochrome printing or color printing by a button operation with respect to the color selection section 504. A paper feeding tray selection section 505 is a button enabling a user to select a paper feeding tray (a sheet feeding stage), where paper (printing sheets) stored in the selected paper feeding tray (the selected sheet feeding stage) is used for printing. In the case where the user has selected “automatic selection” by a button operation with respect to the paper feeding tray selection section 505, first, a paper size of a document to be copied is detected by scanning the document, and a paper feeding tray storing paper (printing sheets) matching the detected paper size is automatically selected. The function application 204 notifies job control section 201 of the print setting that has been set, and is retained by the job control section 201 until the job is completed. A paper size and a paper type of paper (printing sheets) stored in each paper feeding tray (each sheet feeding stage) are retained in advance in the history setting retaining section 205.

FIG. 5B illustrates an example of the message of the counter restriction that is notified in step S307. A message 503, which indicates that it has been the counter restriction, is displayed superimposed on the copy setting screen 501. A user can recognize from the message 503 that the total number of printed pages has reached the upper limit number of pages to be printed.

Now, a print prohibition processing of the first embodiment of the present disclosure will be described. The MFP 1100 in the first embodiment includes the print permission condition mode. The print permission condition mode is a mode that switches to a state in which a printing operation of the MFP 1100 is permitted (a print permission state) in the case where a print permission condition that has been preset is satisfied, and switches to a state in which the printing operation of the MFP 1100 is prohibited (a print prohibition state) in the case where the print permission condition is not satisfied.

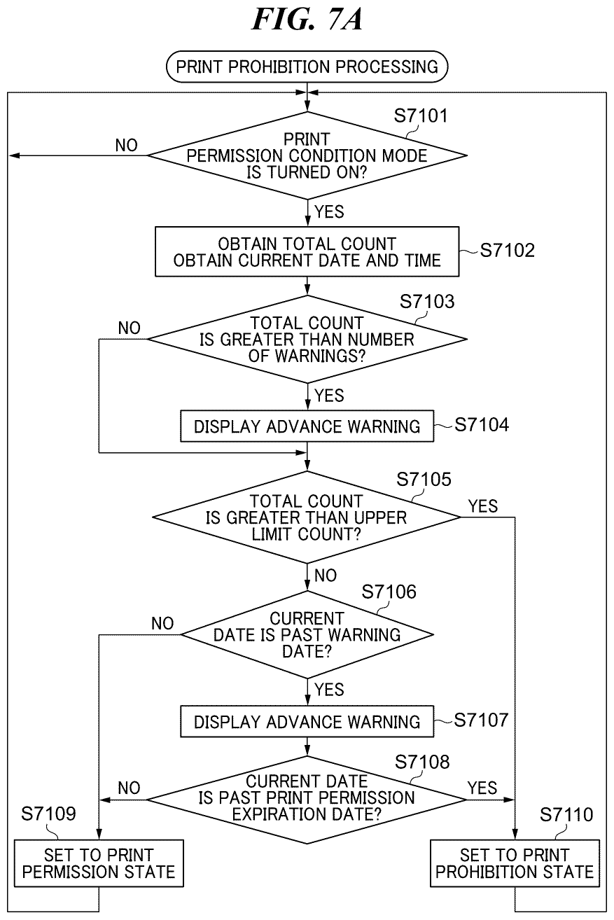

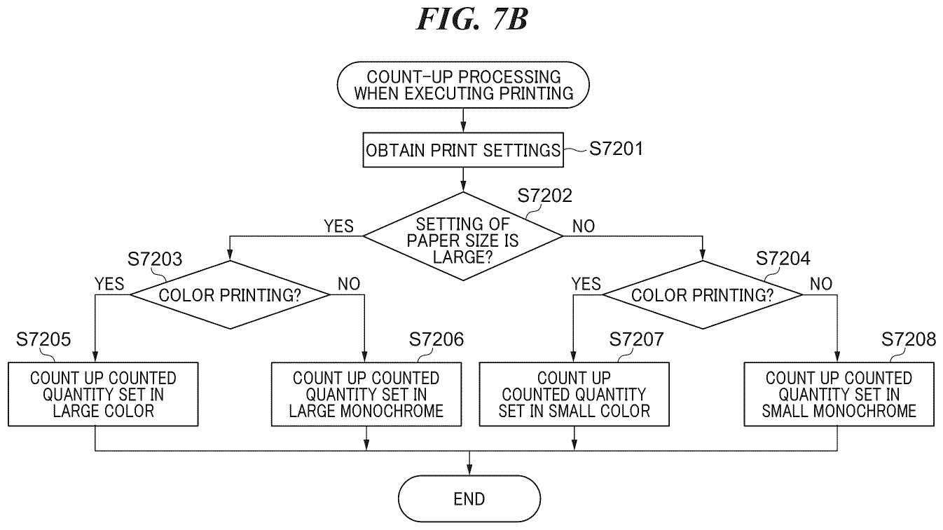

In the case where the print permission condition mode is turned on, switching to the print permission state or switching to the print prohibition state is performed. In the case where the print permission condition mode is turned off, the print prohibition processing illustrated in FIG. 7A, which will be described below, is not performed. The print permission condition includes at least an upper limit count for permitting the printing operation of the MFP 1100, which will be described below, but may also include a print permission period during which the printing operation of the MFP 1100 is permitted.

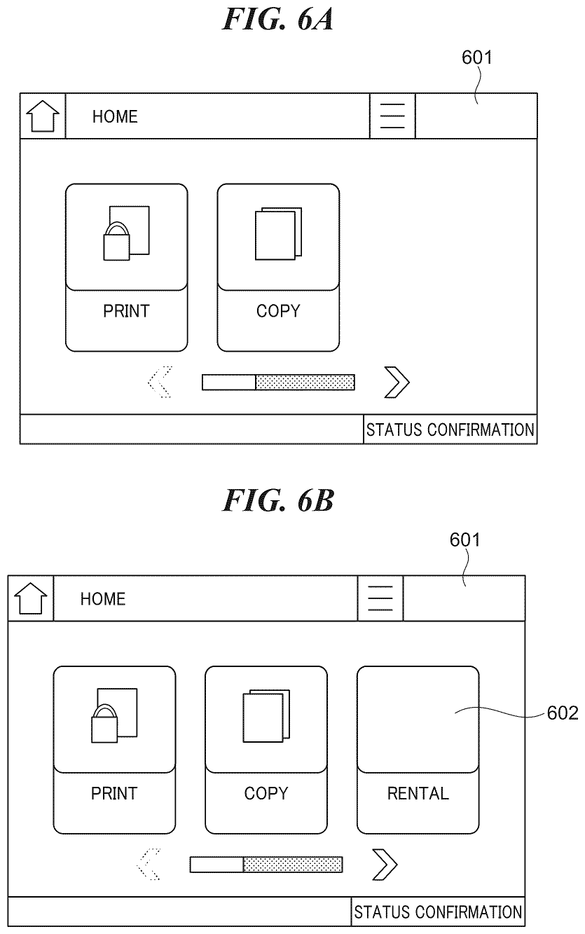

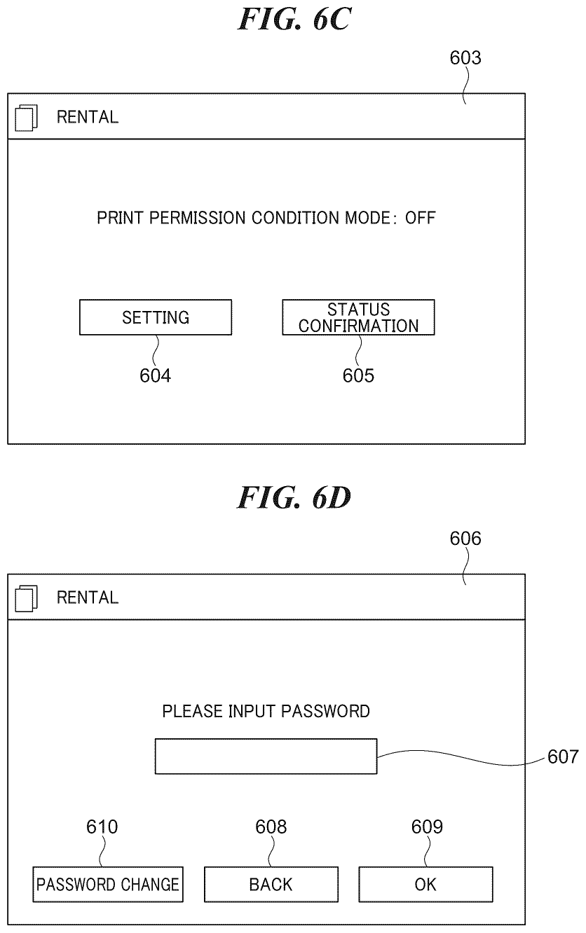

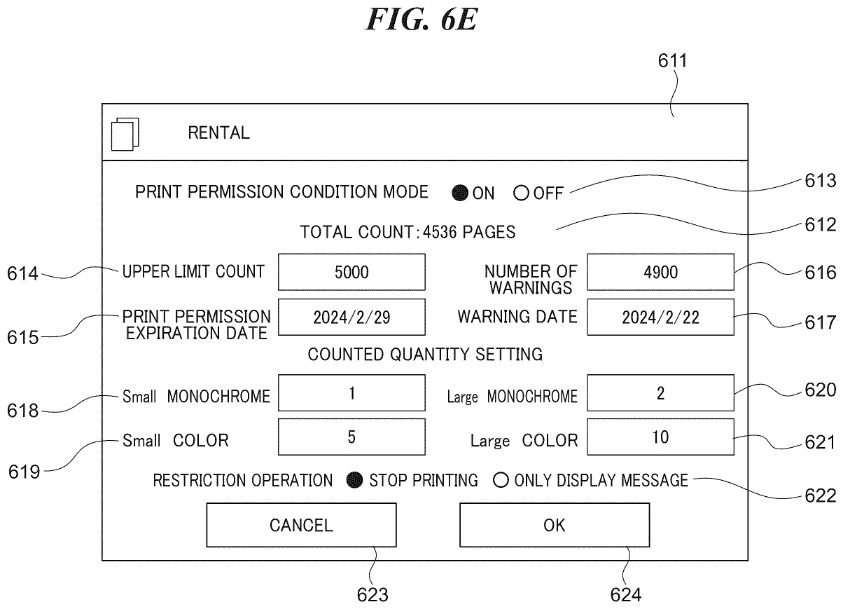

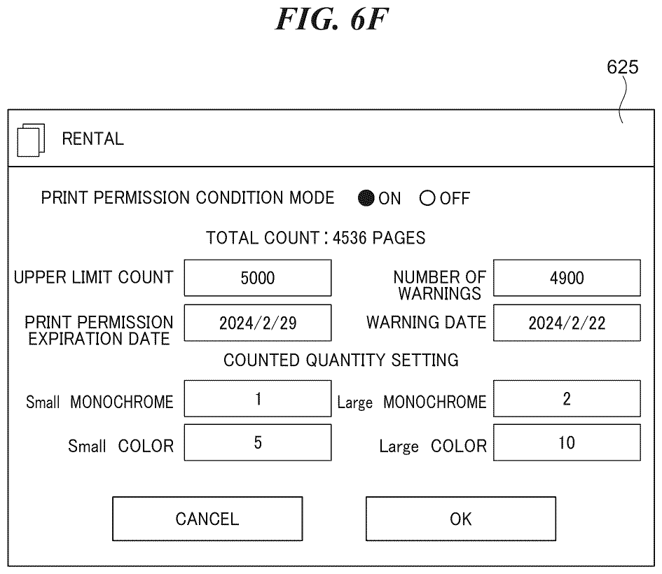

The processing in the print permission condition mode is performed by using the specific function application 204. In the case where the function of the print permission condition mode is not used, the specific function application 204 is not installed and, for example, as illustrated in FIG. 6A, is not displayed on a home screen 601. By installing the specific function application 204, as illustrated in FIG. 6B, a print permission condition setting button 602 is displayed on the home screen 601. For example, when the MFP 1100 is installed, after the specific function application 204 is installed, the service person can start setting the print permission condition by selecting the print permission condition setting button 602. In the following description, the specific function application 204 is referred to as the function application 204.

When detecting that the print permission condition setting button 602 has been selected, the function application 204 causes the operation unit 111 to display a start confirmation screen 603 illustrated in FIG. 6C. The start confirmation screen 603 includes a setting button 604 and a status confirmation button 605, and displays whether the print permission condition mode is currently turned on or off.

In the case where the setting button 604 has been selected, the function application 204 causes the operation unit 111 to display a password input screen 606 illustrated in FIG. 6D. The password input screen 606 includes a password input section 607, a back button 608, an OK button 609, and a password change button 610. In the case where the back button 608 has been selected, the screen returns to the start confirmation screen 603. In the case where the service person inputs a correct password into the password input section 607 and selects the OK button 609, the function application 204 causes the operation unit 111 to display a print permission condition setting screen 611 illustrated in FIG. 6E. In the case where the password inputted by the service person into the password input section 607 is incorrect, the function application 204 causes the operation unit 111 to display an error message.

In the case where the service person has selected the password change button 610 on the password input screen 606 (FIG. 6D), the function application 204 causes the operation unit 111 to display a screen (not shown) for accepting input of a password change. The changed password is saved in the history setting retaining section 205 by the function application 204.

The print permission condition setting screen 611 illustrated in FIG. 6E includes a total count display section 612, setting sections 613 to 622, a cancel button 623, and an OK button 624. In the case where the OK button 624 has been selected, the function application 204 saves values, which have been set in the setting sections 613 to 622, in the history setting retaining section 205. A current total count is displayed on the total count display section 612. The total count refers to a total counted quantity counted up by a count-up processing illustrated in FIG. 7B, which will be described below, which is executed every time a print processing for one sheet of paper is performed.

The setting section 613 accepts an input setting by the service person whether the print permission condition mode is to be turned on or off. The setting section 614 accepts an input operation by the service person of the upper limit count as the print permission condition. The setting section 615 accepts an input operation by the service person of a print permission expiration date as the print permission condition. The setting section 616 accepts an input operation by the service person of the number of warnings, which is a threshold value smaller than the upper limit count for starting an advance warning to be issued before becoming the print prohibition state. The setting section 617 accepts an input operation by the service person of a warning date, which is a date on which the advance warning to be issued before becoming the print prohibition state is started.

A user uses a flat-rate plan in which the usage fee for the MFP 1100 is a fixed amount during a period from a usage start date to the print permission expiration date, regardless of the printing method and the number of times of printing, as long as the total count is less than or equal to the upper limit count. The warning date is set within the period from the usage start date to the print permission expiration date.

The setting sections 618 to 621 (counted quantity accepting sections) accept, from the service person, the input of a counted quantity to be counted up to the total count used for determining the state switching of the print permission condition mode for each paper size and color setting (each printing method). In the first embodiment, the paper size to be printed is divided into two by a threshold value (for example, A4 size) that is preset and can be changed by the service person, and those larger than the threshold value are classified as Large and those smaller than or equal to the threshold value are classified as Small. In other words, there are four classifications based on the combinations of the paper size and the color setting used for printing, that is, whether it is a black and white (monochrome) setting or a color setting. The setting sections 618 to 621 accept, from the service person, input of the setting of the counted quantity in the case where printing is performed in each of these four classifications. The classifications used in the setting of the counted quantity are not limited to the four classifications of the present embodiment. For example, it is also possible to provide a setting section that performs the setting of the counted quantity for each of the conditions, including the amount of toner used per printing of one sheet of paper (one sheet of recording medium) and whether the printing of one sheet of paper is single-sided printing or double-sided printing.

The setting section 622 (a restriction operation accepting section) accepts input of a selection operation by the service person for a restriction operation in the case where the state of the print permission condition mode has become the print prohibition state. The service person can select, via the setting section 622, either stopping printing (a first restriction operation) or only displaying a message (a second restriction operation) as the restriction operation. In the case where stopping printing (the first restriction operation) has been selected as the restriction operation, when the state of the print permission condition mode becomes the print prohibition state, a warning message is displayed. Even if a print instruction is issued from the user after the warning is given, a job generated based on the print instruction remains in a print queue and printing thereof is stopped. In the case where only displaying a message (the second restriction operation) has been selected as the restriction operation, when the state of the print permission condition mode becomes the print prohibition state, only a warning message is displayed. In other words, when a print instruction is issued from the user after a warning message is provided, a job is generated based on the print instruction and printing thereof is executed. In addition, in this case, since the total count is counted up, a user is charged an additional amount for the quantity exceeding the upper limit count. Other restriction operations can be set in the setting section 622 as selectable restriction operations, such as stopping only the operation of the specific function application 204, or stopping the operations of all the function applications 204.

In the case where the cancel button 623 has been selected, the changed settings will not be saved in the history setting retaining section 205 and the screen returns to the start confirmation screen 603.

In the case where the status confirmation button 605 on the start confirmation screen 603 (FIG. 6C) has been selected, the function application 204 displays a status confirmation screen 625 illustrated in FIG. 6F.

The status confirmation screen 625 displays the contents that have been currently set in a form cannot be changed by the user. Since this screen can be displayed without using the password input screen 606, even a user who does not know the password is can confirm the setting contents.

FIG. 7A is a flowchart illustrating a procedure of the print prohibition processing in the first embodiment executed by the MFP 1100. The print prohibition processing illustrated in FIG. 7A is realized by the CPU 101 executing a control program that has been stored in the RAM 102, the ROM 103, or the HDD 104.

As illustrated in FIG. 7A, first, the function application 204 determines whether the print permission condition mode is turned on (step S7101). In the case where the print permission condition mode is determined to not be turned on, i.e., in the case where the print permission condition mode is turned off (NO in step S7101), the print prohibition processing remains in step S7101.

In the case where the print permission condition mode is determined to be turned on (YES in step S7101), the function application 204 obtains, from the history setting retaining section 205, the total count, the upper limit count, the print permission period, the number of warnings, and the warning date (step S7102).

Next, the function application 204 determines whether the total count is greater than the number of warnings obtained in step S7102 (step S7103). When the total count is determined to be a value less than or equal to the number of warnings (NO in step S7103), the print prohibition processing proceeds to step S7105.

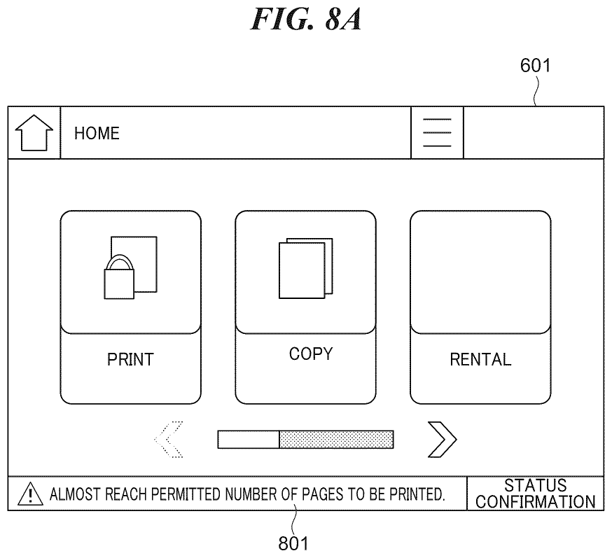

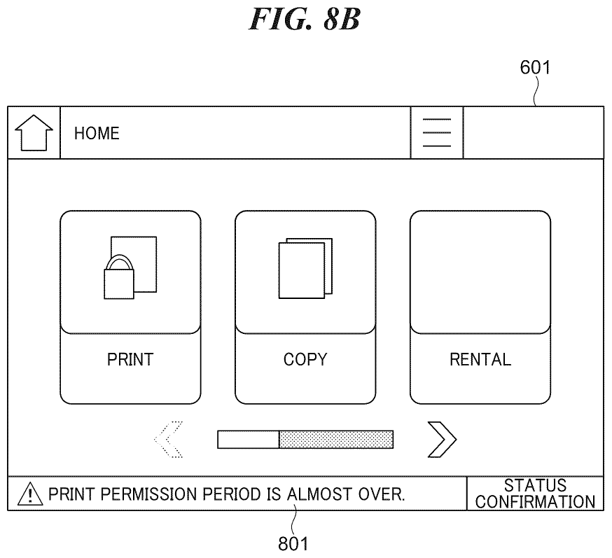

In the case where the total count is determined to be greater than the number of warnings (YES in step S7103), the function application 204 displays an advance warning (step S7104), and then the print prohibition processing proceeds to step S7105. As illustrated in FIG. 8A, a message display section 801 of the home screen 601 displays a message, as the advance warning, which indicates that a permitted number of pages to be printed is almost reached. Thus, the user can recognize that the total count almost reaches the upper limit count.

Next, the function application 204 determines whether the total count is greater than the upper limit count (step S7105). When the total count is determined to be greater than the upper limit count (YES in step S7105), the print prohibition processing proceeds to step S7110. In the case where the total count is determined to be a value less than or equal to the upper limit count (NO in step S7105), the function application 204 determines whether the current date is later than (is past) the warning date (step S7106). In the case where it is determined that the current date is not later than (is not past) the warning date (NO in step S7106), the print prohibition processing proceeds to step S7108.

In the case where the current date is determined to be later than (is past) the warning date (YES in step S7106), the function application 204 displays an advance warning (step S7107), and then the print prohibition processing proceeds to step S7108. As illustrated in FIG. 8B, the message display section 801 of the home screen 601 displays an advance warning message, which indicates that the print permission period is almost over. Thus, the user can recognize that the print permission period is almost over.

Next, the function application 204 determines whether the current date is later than (is past) the print permission expiration date (step S7108). Where the current date is determined not to be later than (is not past) the print permission expiration date (NO in step S7108), the function application 204 sets the MFP 1100 to the print permission state (step S7109). In the case where the MFP 1100 has been set to the print permission state, all the function applications 204 can issue a print instruction with respect to the job control section 201, and the printing operation in the MFP 1100 is permitted. Thereafter, the print prohibition processing returns to step S7101.

In the case where the current date is determined to be later than (is past) the print permission expiration date (YES in step S7108), the print prohibition processing proceeds to step S7110.

In step S7110, the function application 204 sets the MFP 1100 to the print prohibition state. In the case where the MFP 1100 has been set to the print prohibition state, the user is notified that printing by means of the MFP 1100 is prohibited.

In the case where the MFP 1100 has been set to the print prohibition state and the restriction operation has been set to stopping printing, even if a print instruction is issued from the user, all the function applications 204 do not issue a print instruction with respect to the job control section 201, and the printing operation in the MFP 1100 is prohibited. In the case where the MFP 1100 has been set to the print prohibition state and the restriction operation has been set to only displaying a message, when a print instruction is issued from the user, all the function applications 204 issue a print instruction with respect to the job control section 201, and the printing operation in the MFP 1100 is executed.

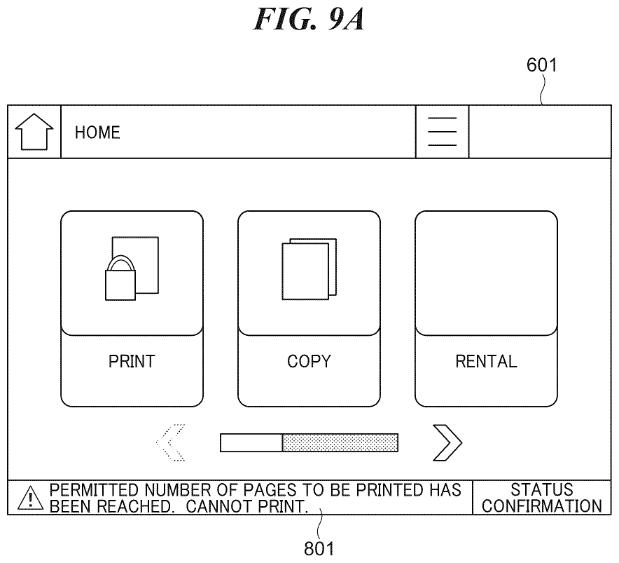

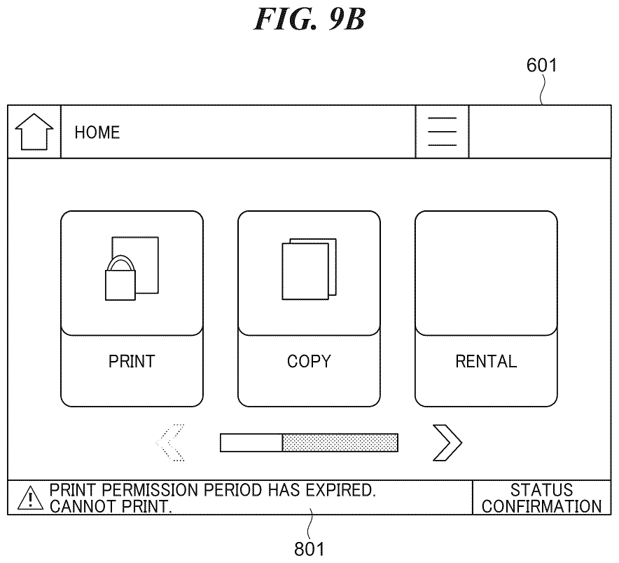

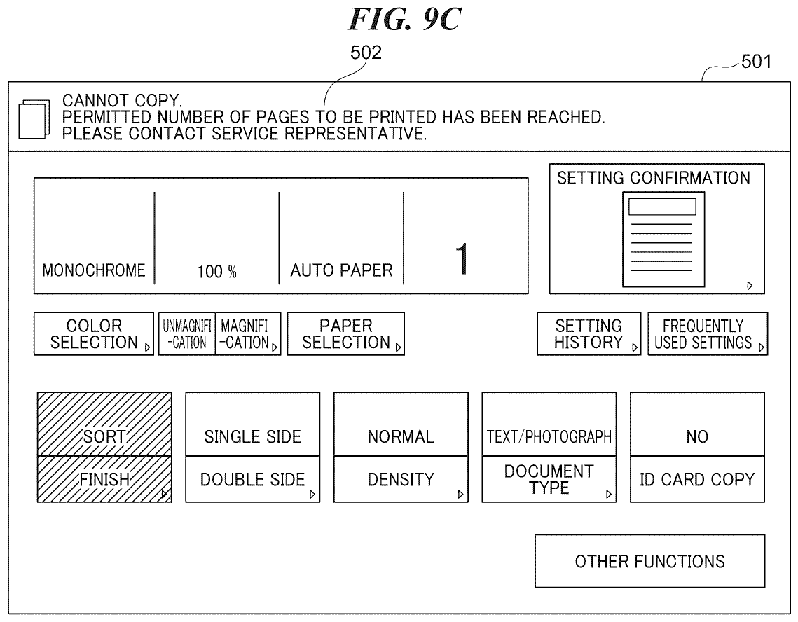

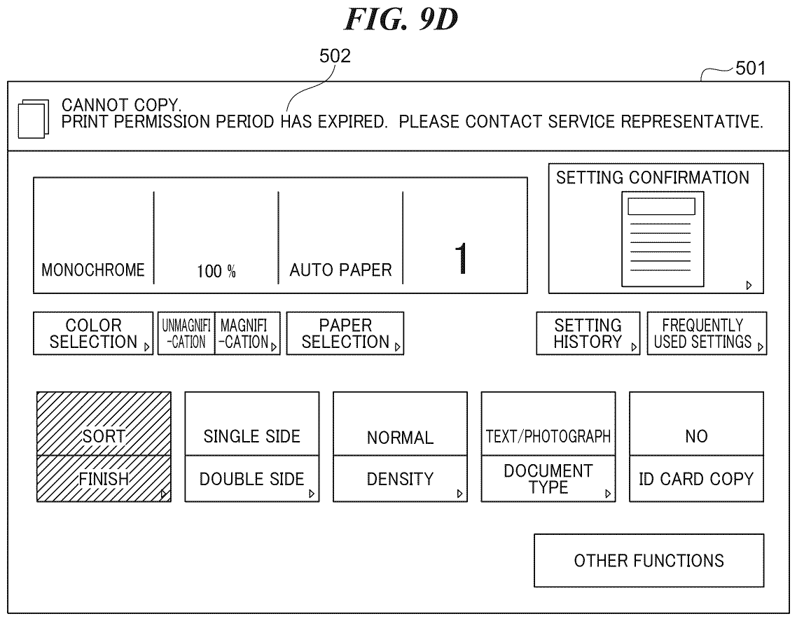

In the case where the MFP 1100 has been set to the print prohibition state, regardless of whether the restriction operation is set to stopping printing or is set to only displaying a message, the error control section 202 displays an unable-to-print message on the message display section 801 of the home screen 601 illustrated in FIGS. 9A and 9B (a notification of print prohibition). The error control section 202 also displays an unable-to-print message on the setting screen of the function application 204 that performs printing. A description will be provided using the copy function as an example. In FIG. 9C, a message, which indicates that copying is not possible because the permitted number of pages to be printed has been reached, is displayed, as the unable-to-print message, on a number-of-printable-pages display section 502. In addition, in FIG. 9D, a message, as the unable-to-print message that indicates that the print permission period has expired, is displayed on a number-of-printable-pages display section 502. This enables the error control section 202 to notify the user that the MFP 1100 is in the print prohibition state by displaying various kinds of the unable-to-print messages.

FIG. 7B is a flowchart illustrating a procedure of the count-up processing when executing printing in the first embodiment. Similar to the print prohibition processing illustrated in FIG. 7A, the count-up processing illustrated in FIG. 7B is also realized by the CPU 101 (a counted quantity setting unit) executing a control program stored in the RAM 102, the ROM 103, or the HDD 104.

The job control section 201 controls the printer 113 via the printer I/F 108, and starts the count-up processing illustrated in FIG. 7B every time a print processing for one sheet of paper is executed.

As illustrated in FIG. 7B, first, in step S7201, the job control section 201 obtains print settings when executing the print processing for one sheet of paper. The print settings obtained include the color setting, which has been set by the color selection section 504 on the copy setting screen 501, and the setting of the paper size contained in the paper feeding tray (the sheet feeding stage) that has been set by the paper feeding tray selection section 505. Specifically, the function application 204 obtains these print settings during job execution. The function application 204 then notifies the job control section 201 of these obtained print settings.

Next, in step S7202, the job control section 201 determines whether the setting of the paper size in the print settings obtained in step S7201 is Large or Small. Specifically, the paper size is divided into two categories based on a certain reference size, and the setting of the paper size is determined based on which category it falls into. The reference size is stored in advance as a setting.

In the case where the setting of the paper size is determined to be Large (YES in step S7202), the job control section 201 proceeds to step S7203 and determines whether the color setting in the print settings obtained in step S7201 is a color setting or a monochrome setting.

In the case where the color setting in the print settings is determined to have been obtained in step S7201 is not a color setting but a monochrome setting (NO in step S7203), the job control section 201 adds a value set in the Large monochrome setting of the counted quantity setting to the total count (step S7206), and ends the count-up processing illustrated in FIG. 7B.

In the case where the color setting in the print settings that have been obtained in step S7201 determined to be a color setting (YES in step S7203), the job control section 201 adds a counted quantity (here, “10”) that has been set in the setting section 621 (the Large color setting) to the total count (step S7205), and ends the count-up processing illustrated in FIG. 7B.

In the case where the setting of the paper size is determined to be Small (NO in step S7202), the job control section 201 proceeds to step S7204 and determines whether the color setting in the print settings obtained in step S7201 is a color setting or a monochrome setting.

In the case where the color setting in the print settings obtained in step S7201 is determined not to be a color setting but a monochrome setting (NO in step S7204), the job control section 201 adds a value that has been set in the Small monochrome setting of the counted quantity setting to the total count (step S7208), and ends the count-up processing illustrated in FIG. 7B.

In the case where the color setting in the print settings obtained in step S7201 is determined to be a color setting (YES in step S7204), the job control section 201 adds a value that has been set in the Small color setting of the counted quantity setting to the total count (step S7207), and ends the count-up processing illustrated in FIG. 7B.

The print prohibition processing illustrated in FIG. 7A and the count-up processing illustrated in FIG. 7B enables dynamically deciding the counted quantity when printing for one sheet of paper is completed, and the MFP 1100 can operate at a charge rate for each condition based on the contents of the contract. In other words, it becomes possible to provide a rental service by changing a color printing charge rate, a monochrome printing charge rate, and a charge rate based on the paper size. Thus, it is possible to provide rental services with print permission conditions that suit customers, etc. For example, the service person can use the setting sections 618 to 621 to change the counted quantity for each classification, enabling setting discounts on certain functions for customers who frequently use a particular classification (e.g., color printing) or for customers with long-term contracts.

Next, a second embodiment of the present disclosure will be described. The description of the second embodiment will mainly focus on differences between the second embodiment and the above-described first embodiment. In the following description, the same hardware and software configurations as those in the first embodiment are denoted by the same reference numerals and descriptions will be omitted herein.

The second embodiment includes similar aspects described above with respect to the first embodiment, such as the counted quantity added to the total count in the count-up processing is set based on the printing method. While in the first embodiment, as an example of the printing method includes the combinations of the paper size and the color setting, in the second embodiment, an example of the printing method includes a paper type of paper (printing sheets) used for printing.

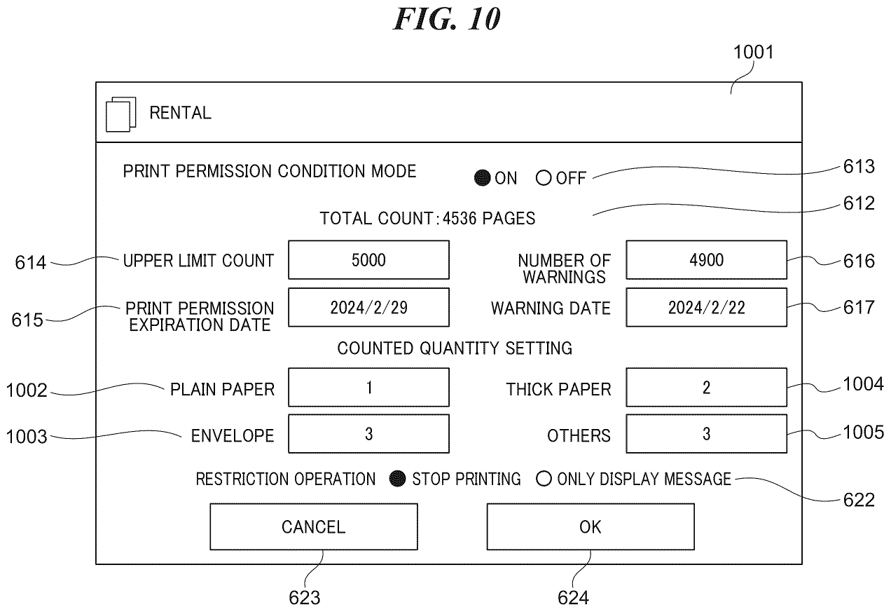

FIG. 10 is a diagram illustrating a print permission condition setting screen 1001, which is displayed on the operation unit 111, according to the second embodiment.

Similar to the print permission condition setting screen 611 according to the first embodiment illustrated in FIG. 6E, the print permission condition setting screen 1001 includes a total count display section 612, setting sections 614 to 617, a cancel button 623, and an OK button 624. However, the print permission condition setting screen 1001 differs from the print permission condition setting screen 611 in that the print permission condition setting screen 1001 includes setting sections 1002 to 1005 instead of the setting sections 618 to 622.

The setting sections 1002 to 1005 (counted quantity accepting sections) accept the inputted counted quantity settings made by the service person in accordance with classifications of the paper types that have been retained in the history setting retaining section 205. The classifications of the paper types that have been retained are paper types with a high consumption degree of consumables of the MFP 1100, such as ink, but any paper type that enables printing by the MFP 1100 may be set.

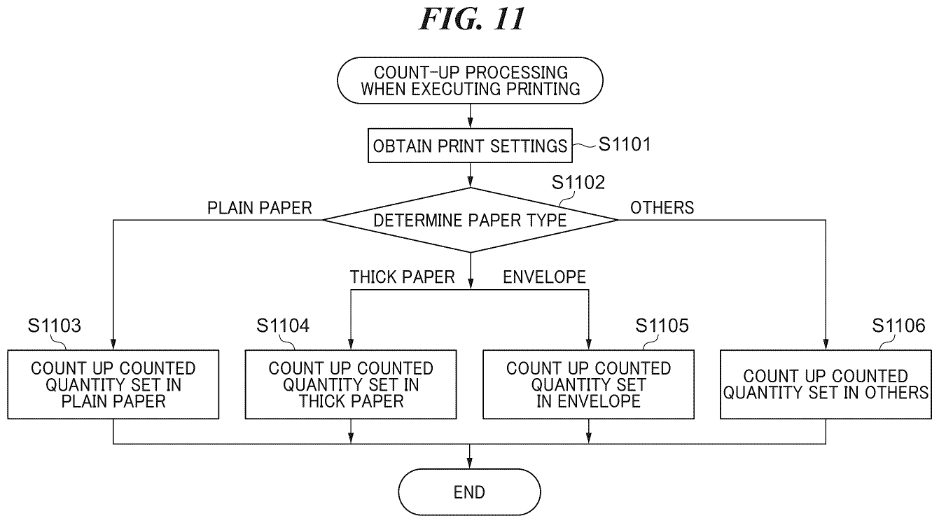

FIG. 11 is a flowchart illustrating a procedure of a count-up processing when executing printing according to the second embodiment. Similar to the count-up processing illustrated in FIG. 7B, the count-up processing illustrated in FIG. 11 is also realized by the CPU 101 executing a control program stored in the RAM 102, the ROM 103, or the HDD 104.

The job control section 201 controls the printer 113 via the printer I/F 108, and performs the count-up processing illustrated in FIG. 11 every time a print processing for one sheet of paper is executed.

As illustrated in FIG. 11, first, in step S1101, the job control section 201 obtains a print setting when executing the print processing for one sheet of paper. The obtained print setting refers to a paper type of paper (printing sheets) stored in the paper feeding tray (the sheet feeding stage) that has been set by the paper feeding tray selection section 505. Specifically, during job execution, the function application 204 obtains, from the history setting retaining section 205, the paper type of the paper (the printing sheets) stored in the paper feeding tray (the sheet feeding stage) that has been set by the paper feeding tray selection section 505, and notifies the job control section 201 of the paper type as the print setting.

The paper type obtained as the print setting is set by the user when printing. However, this is not seen to be limiting as long as the paper type is obtained as the print setting, and for example, a paper type determination sensor may be installed in the document tray, and the paper type of the paper (the printing sheets) contained in the paper feeding tray (the sheet feeding stage) that has been set by the paper feeding tray selection section 505 may be determined by using the paper type determination sensor.

Next, in step S1102, the job control section 201 determines whether the paper type obtained in step S1101 is one of the paper types of the counted quantity settings in the setting sections 1002 to 1005.

In the case where the paper type obtained in step S1101 is determined to be plain paper (“plain paper” in step S1102), the job control section 201 adds a value of the counted quantity set in the setting section 1002 to the total count (step S1103), and ends the count-up processing illustrated in FIG. 11.

In the case where the paper type obtained in step S1101 is determined to be thick paper (“thick paper” in step S1102), the job control section 201 adds a value of the counted quantity set in the setting section 1004 to the total count (step S1104), and ends the count-up processing illustrated in FIG. 11.

In the case where the paper type obtained in step S1101 is determined to be envelope (“envelope” in step S1102), the job control section 201 adds a value of the counted quantity set in the setting section 1003 to the total count (step S1105), and ends the count-up processing illustrated in FIG. 11.

In the case where the paper type obtained in step S1101 is determined to not be one of the paper types retained in the history setting retaining section 205 (“others” in step S1102), the count-up processing illustrated in FIG. 11 proceeds to step S1106. The “others” paper type is not limited as long as it is a paper type that is not considered to be plain paper, thick paper, or envelope, and may be, for example, coated paper.

In step S1106, the job control section 201 adds a value of the counted quantity set in the setting section 1005 to the total count, and ends the count-up processing illustrated in FIG. 11.

According to the count-up processing illustrated in FIG. 11, it is possible to decide the counted quantity for each paper type of paper (printing sheets) to be printed, and charging can be set based on the consumption degree of the consumables of the MFP 1100.

The configurations of the second embodiment and the first embodiment can be combined. For example, the setting sections 1002 to 1005 can be added to the print permission condition setting screen 611 illustrated in FIG. 6E.

In the first and second embodiments, the service person performs the input operation of the counted quantity setting according to the printing method by using the print permission condition setting screen 611 illustrated in FIG. 6E or the print permission condition setting screen 1001 illustrated in FIG. 10, but this is not seen to be limiting. The upper limit count and the counted quantity to be added for each printing method may be preset for each contract plan in the history setting retaining section 205, and the user may be prompted to change to a contract plan that meets customer needs.

For example, the function application 204 (a calculating unit) first calculates a ratio of the total count of color printing (a first printing method) to the total count of monochrome printing (a second printing method) at a predetermined timing. The predetermined timing is not seen to be limited, and can be, for example, a timing when the total count becomes greater than the upper limit count.

In the case where the calculated ratio is greater than a predetermined value, the function application 204 (a notifying unit) displays, on the operation unit 111, a message enabling the user to change the current contract plan to a contract plan with a smaller counted quantity setting for color printing. This message (a contract plan change message) is displayed, for example, on the message display section 801 or the number-of-printable-pages display section 502 in FIGS. 9A, 9B, 9C, and 9D together with the unable-to-print message.

Similarly, for example, at the above-described predetermined timing, a ratio of the total count of printing on a paper size larger than a threshold value (for example, A4 size) (the first printing method) to the total count of printing on a paper size equal to or smaller than the threshold value (the second printing method) is calculated.

Next, in the case where the calculated ratio is greater than a predetermined value, the function application 204 (the notifying unit) displays, on the operation unit 111, a message enabling the user to change the current contract plan to a contract plan with a smaller counted quantity setting when printing on a paper size larger than the threshold value. This message (a contract plan change message) is displayed, for example, on the message display section 801 or the number-of-printable-pages display section 502 in FIGS. 9A, 9B, 9C, and 9D together with the unable-to-print message.

The ratio of the total count, similar to the input of the counted quantity into each of the setting sections 618 to 621 illustrated in FIG. 6E, may be calculated for each of four classifications consisting of the combinations of the paper size, and the color setting that is used for printing.

By displaying the contract plan change message at the predetermined timing in this manner, when renewing a contract, the user can change, based on the usage record of the contract up to now, the contents of the contract to better meet the user's needs.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-099544, filed on Jun. 20, 2024, which is hereby incorporated by reference herein in its entirety.

What is claimed is:

1. A printing apparatus comprising:
a printing unit;
at least one processor; and
a memory in communication with to the processor storing instructions that, when executed by the processor, cause the processor to:
display a screen for accepting a first quantity by which a printing count value is counted up when an image is printed in monochrome on one sheet and a second quantity by which the printing count value is counted up when an image is printed in color on one sheet; and
restrict printing performed by the printing unit based on the printing count value and a printing upper limit value.

2. The printing apparatus according to claim 1, wherein
the processor is caused to further accept a selection of a first restriction operation or a second restriction operation as a restriction operation for restricting the printing,
wherein in a case where the selection of the first restriction operation is accepted, after the printing is restricted, printing of a job is stopped based on a received print instruction, and
wherein in a case where the selection of the second restriction operation is accepted, after the printing is restricted, printing of a job is executed based on a received print instruction.

3. The printing apparatus according to claim 1, wherein in a case where the printing count value exceeds the printing upper limit value, the printing performed by the printing unit is restricted.

4. The printing apparatus according to claim 1, wherein a predetermined notification is displayed on the screen when the printing count value exceeds the printing upper limit value.

5. The printing apparatus according to claim 4, wherein the predetermined notification includes a character string that notifies a user that a printing upper limit has been reached.

6. The printing apparatus according to claim 4, wherein the predetermined notification includes a character string enabling a user to contact a service person.

7. The printing apparatus according to claim 1, wherein the first quantity is a quantity by which the printing count value is counted up when an image is printed in monochrome on one sheet with a first size, and
wherein the screen accepts a third quantity by which the printing count value is counted up when an image is printed in monochrome on one sheet with a second size larger than the first size.

8. The printing apparatus according to claim 7, wherein the second quantity is a quantity by which the printing count value is counted up when an image is printed in color on one sheet with the first size, and
the screen accepts a fourth quantity by which the printing count value is counted up when an image is printed in color on one sheet with the second size larger than the first size.

9. The printing apparatus according to claim 1, wherein the processor enables inputting a period during which the printing is permitted.

10. The printing apparatus according to claim 1, wherein the processor enables setting the printing upper limit value.

11. A method for a printing apparatus including a printing unit, the method comprising:
displaying a screen for accepting a first quantity by which a printing count value is counted up when an image is printed in monochrome on one sheet and a second quantity by which the printing count value is counted up when an image is printed in color on one sheet; and
restricting printing performed by the printing unit based on the printing count value and a printing upper limit value.

12. A non-transitory computer-readable storage medium storing a program for causing a computer to execute a method for a printing apparatus including a printing unit, the method comprising:
displaying a screen for accepting a first quantity by which a printing count value is counted up when an image is printed in monochrome on one sheet and a second quantity by which the printing count value is counted up when an image is printed in color on one sheet; and
restricting printing performed by the printing unit based on the printing count value and a printing upper limit value.
